(19) United States
(12) Patent Application Publication
(10) Pub. No.: US 2013/0166893 A1
(43) Pub. Date: Jun. 27, 2013

(54) AUXILIARY CARD INITIALIZATION ROUTINE

(71) Applicants: Gautam A. Dusija, San Jose, CA (US); Jianmin Huang, Sunnyvale, CA (US); Chris Avila, Sunnvale, CA (US)

(72) Inventors: Gautam A. Dusija, San Jose, CA (US); Jianmin Huang, Sunnyvale, CA (US); Chris Avila, Sunnvale, CA (US)

(73) Assignee: SANDISK TECHNOLOGIES INC., Plano, TX (US)

(21) Appl. No.: 13/336,223

(22) Filed: Dec. 23, 2011

(51) Int. Cl. G06F 9/445

(52) U.S. Cl. 713/2

(57) ABSTRACT

A memory system or flash card may be initialized from a protected block of flash memory as a backup process. If there is an error during regular card initialization and the firmware for the card cannot be loaded, the card may be inaccessible to a user. Booting with a protected block of memory may be used to load a different version of the firmware that can still initialize the card despite the error from loading the other firmware.

### TECHNICAL FIELD

This application relates generally to memory devices. More specifically, this application relates to auxiliary booting of non-volatile semiconductor flash memory.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. There may be any number of booting or initialization errors for a flash memory that results in the flash memory being dead to the user. For example, if a control block is overcycled, or a read error occurs during memory initialization, the flash memory may be put in read only memory (ROM) mode and be inaccessible to a user.

### SUMMARY

In order to address the problems noted above, a card or memory system may include an auxiliary booting process that uses a protected block in the flash memory chip. In particular, if the main or primary source for loading the firmware is corrupted, there may be a backup or secondary source within the protected block for loading a version of the firmware as an attempt to initialize the memory system despite the corruption. The protect block may be referred to as USERROM and may include multiple blocks that are not accessible by the host.

According to a first aspect, a method is disclosed for initializing a memory system with a non-volatile storage device having a controller and blocks of memory. The controller attempts to boot the non-volatile storage device upon each power cycle and accesses a protected block of the non-volatile storage device when the attempts to boot fail. The protected block includes one or more of the blocks of memory that provide an auxiliary boot process. The controller determines whether the auxiliary boot process is valid and boots the non-volatile storage device with the auxiliary boot process when the attempted boot fails and when the auxiliary boot process is valid.

According to another aspect, a flash memory device includes a non-volatile storage having an array of memory blocks storing data and a controller in communication with the non-volatile storage. The controller is configured for identifying when a first firmware of the flash memory device cannot be loaded during the initializing of the flash memory device, and accessing a boot block stored in a protected block in the non-volatile storage when the first firmware of the flash memory device cannot be loaded. The controller initializes the flash memory device from the boot block stored in the protected block, and the initialization includes loading a second firmware for the flash memory device. The flash memory is updated from the second firmware.

According to another aspect, a method for initializing a non-volatile storage device in a memory system that includes a controller in communication with the non-volatile storage is disclosed. The method includes booting a non-volatile storage device from a protected read only memory on the non-volatile storage device. Backup firmware is loaded as part of the booting from the protected read only memory. A regular firmware is identified on the non-volatile storage device after booting from the protected read only memory. The regular firmware is stored outside the protected read only memory. The non-volatile storage device is updated with the original firmware.

### BRIEF DESCRIPTION OF THE DRAWINGS

FIG. 1 is a block diagram of a host connected with a memory system having non-volatile memory.

FIG. 2 is a block diagram of an exemplary flash memory system controller for use in the system of FIG. 1.

FIG. 3 is an example physical memory organization of the system of FIG. 1.

FIG. 4 is an expanded view of a portion of the physical memory of FIG. 3.

FIG. 5 is an initialization process.

### BRIEF DESCRIPTION OF THE PRESENTLY PREFERRED EMBODIMENTS

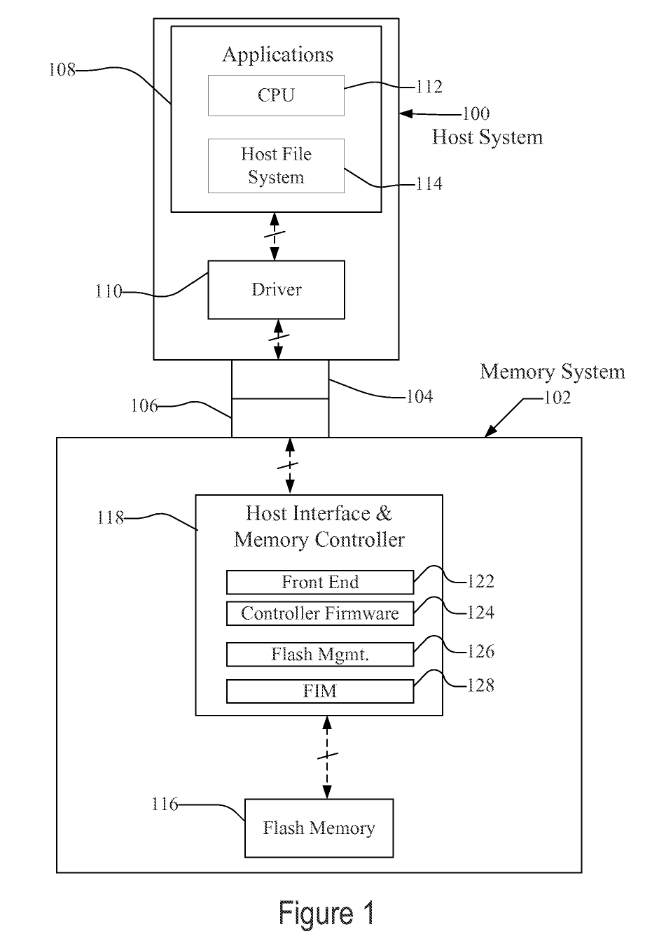

A flash memory system suitable for use in implementing aspects of the invention is shown in FIGS. 1-4. A host system 100 of FIG. 1 stores data into and retrieves data from a flash memory 102. The flash memory may be embedded within the host, such as in the form of a solid state disk (SSD) drive installed in a personal computer. Alternatively, the memory 102 may be in the form of a flash memory card that is removably connected to the host through mating parts 104 and 106 of a mechanical and electrical connector as illustrated in FIG. 1. A flash memory configured for use as an internal or embedded SSD drive may look similar to the schematic of FIG. 1, with one difference being the location of the memory system 102 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 100 of FIG. 1 may be viewed as having two major parts, insofar as the memory 102 is concerned, made up of a combination of circuitry and software. They are an applications portion 108 and a driver portion 110 that interfaces with the memory 102. There may be a central processing unit (CPU) 112 implemented in circuitry and a host file system 114 implemented in hardware. In a PC, for example, the applications portion 108 may include a processor 112 running word processing, graphics, control or other popular application software. In a camera, cellular telephone or other host system 114 that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host 100 to which the memory system 102 is connected for passing data back and forth and controls the memory 116. The system controller 118 may convert between logical addresses of data used by the host 100 and physical addresses of the flash memory 116 during data programming and reading. Functionally, the system controller 118 may include a front end 122 that interfaces with the host system, controller logic 124 for coordinating operation of the memory 116, flash management logic 126 for internal memory management operations such as garbage collection, and one or more flash interface modules (FIMs) 128 to provide a communication interface between the controller with the flash memory 116.

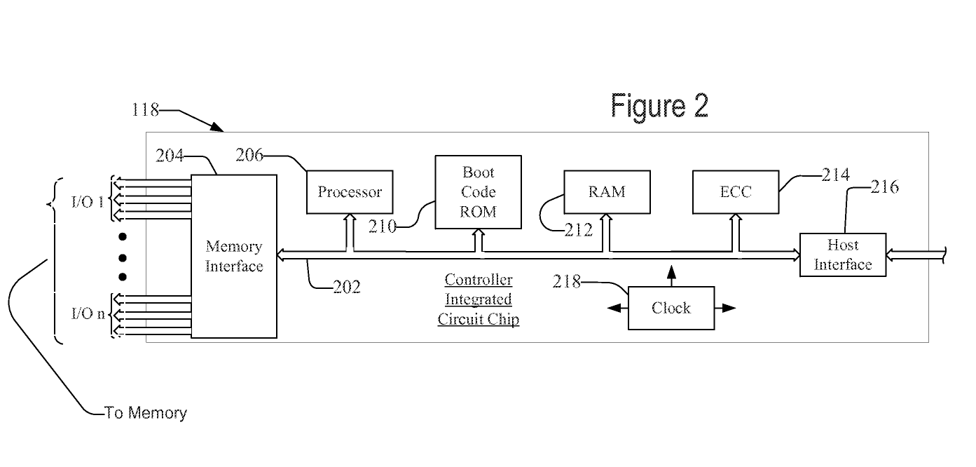

The system controller 118 may be implemented on a single integrated circuit chip, such as an application specific integrated circuit (ASIC) such as shown in FIG. 2. The processor 206 of the system controller 118 may be configured as a multi-thread processor capable of communicating via a memory interface 204 having I/O ports for each memory bank in the flash memory 116. The system controller 118 may include an internal clock 218. The processor 206 communicates with an error correction code (ECC) module 214, a RAM buffer 212, a host interface 216, and boot code ROM 210 via an internal data bus 202.

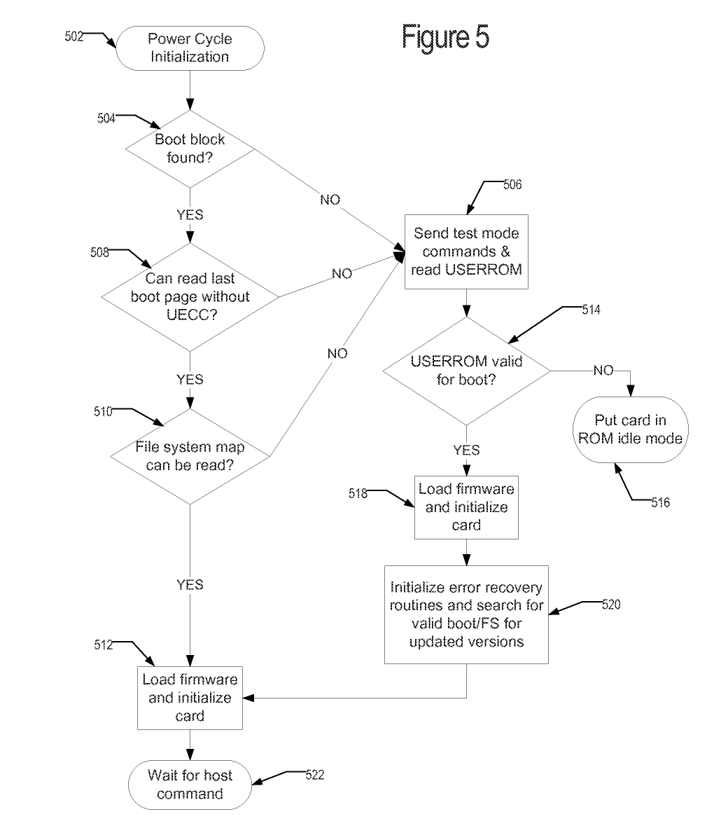

The ROM 210 may be used to initialize a memory system 102, such as a flash memory device. The memory system 102 that is initialized may be referred to as a card. The ROM 210 in FIG. 2 may be a region of read only memory whose purpose is to provide boot code to the RAM for processing a program, such as the initialization and booting of the memory system 102 as discussed below. The ROM 210 may also be referred to as boot code ROM. The ROM may be present in the ASIC rather than the flash memory chip, while a USERROM is a special protected block in the flash memory chip. USERROM is a form of read only memory in the flash memory chip. In one embodiment, the memory system 102 may be initialized on each power cycle and the USERROM in the flash memory may be used to load firmware upon initialization if the primary mechanism for loading the firmware is corrupted. In particular, FIG. 5 illustrates utilizing the USERROM for backup initialization of a card. USERROM may be a dedicated protected physical block in the flash memory that is modified for this auxiliary booting process and includes firmware for initializing a card as part of the initialization process. The USERROM may be protected because it is dedicated for device data rather than host data. As described below, the USERROM may be referred to as a protected block and may include one or more protected blocks in the flash memory.

The initialization of a card may also be referred to as a boot process. The boot process includes the powering up of the card. The process may include the loading of firmware so the card can communicate with a host. The boot process may include executing programs or code stored in boot ROMs. The software or firmware that is loaded as part of the boot process may be needed to use the card. As described, an auxiliary booting process may store boot code or firmware in a protected memory (e.g. USERROM) that can be accessed if the regular booting process is corrupted or overcycled. The boot code and firmware stored in the protected memory may be loaded into that memory during the first installation of the firmware onto the card. This backup firmware that is stored in the protected memory may become outdated, but may still be used as part of the auxiliary booting process so that the card can be functional.

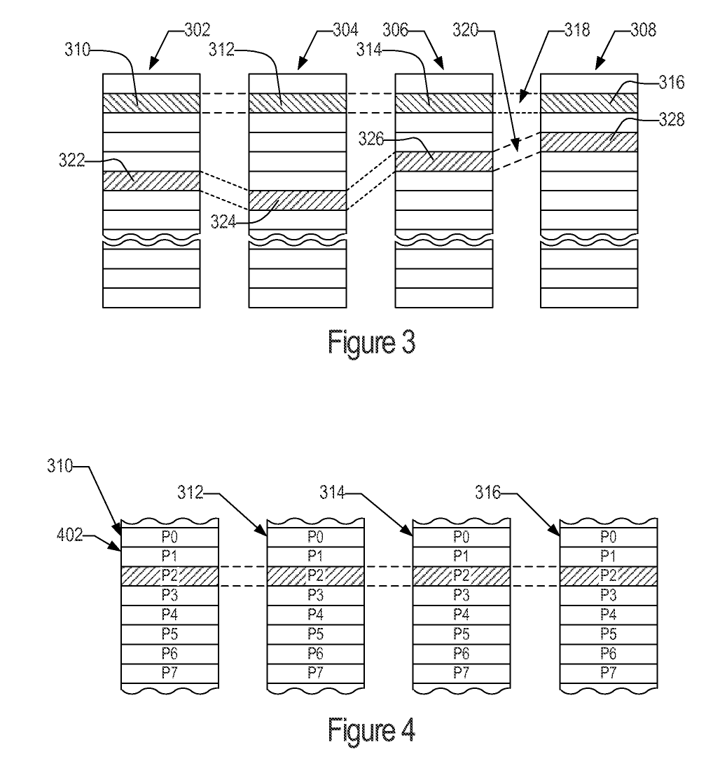

FIG. 3 conceptually illustrates an organization of the flash memory 116 (FIG. 1) as a cell array. Certain blocks or cell arrays may be ROM that is only accessible by the device and not the user. As described below, the ROM may be used as an auxiliary booting process. The flash memory 116 may include multiple memory cell arrays which are each separately controlled by a single or multiple memory controllers 118. Four planes or sub-arrays 302, 304, 306, and 308 of memory cells may be on a single integrated memory cell chip, on two chips (two of the planes on each chip) or on four separate chips. The specific arrangement is not important to the discussion below. Of course, other numbers of planes, such as 1, 2, 8, 16 or more may exist in a system. The planes are individually divided into groups of memory cells that form the minimum unit of erase, hereinafter referred to as blocks. Blocks of memory cells are shown in FIG. 3 by rectangles, such as blocks 310, 312, 314, and 316, located in respective planes 402, 304, 306, and 308. There can be any number of blocks in each plane. Certain blocks may be reserved as a protected block or USERROM for auxiliary booting of the flash memory.

As mentioned above, the block of memory cells is the unit of erase, the smallest number of memory cells that are physically erasable together. For increased parallelism, however, the blocks may be operated in larger metablock units. One block from each plane is logically linked together to form a metablock. The four blocks 310, 312, 314, and 316 are shown to form one metablock 318. In one embodiment, the ROM is one or more metablocks. All of the cells within a metablock are typically erased together. The blocks used to form a metablock need not be restricted to the same relative locations within their respective planes, as is shown in a second metablock 320 made up of blocks 322, 324, 326, and 328. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

The individual blocks are in turn divided for operational purposes into pages of memory cells, as illustrated in FIG. 4. The memory cells of each of the blocks 310, 312, 314, and 316, for example, are each divided into eight pages P0-P7. Alternatively, there may be 16, 32 or more pages of memory cells within each block. The page is the unit of data programming and reading within a block, containing the minimum amount of data that are programmed or read at one time. However, in order to increase the memory system operational parallelism, such pages within two or more blocks may be logically linked into metapages. A metapage 402 is illustrated in FIG. 3, being formed of one physical page from each of the four blocks 310, 312, 314, and 316. The metapage 402, for example, includes the page P2 in each of the four blocks but the pages of a metapage need not necessarily have the same relative position within each of the blocks. A metapage may be the maximum unit of programming.

FIG. 5 is an initialization process. A flash card (e.g. memory system 102) may utilize ROM code for initialization on every power cycle. In block 502, the power cycle initialization process begins. In block 504, the initialization process looks for the boot block for initializing and booting the card. The normal boot block, along with the file system, may be stored in flash memory on the card. The normal boot block may be referred to as the original or standard boot block that is used for initializing and booting the card when there is no error condition. As discussed below, there may be an additional boot block stored in a protected block in the flash memory for when the normal boot block stored elsewhere on the card is corrupted or overcycled.

When the boot block is found on the card, the boot page is read to determine whether the last boot page can be read without an Uncorrectable Error Correction Code (UECC) in block 508. When the last boot page can be read without UECC, the file system map is checked to verify that it can be read in block 510. When the file system map can be read, the card's firmware is loaded and the card is initialized in block 512. The card's firmware that is loaded may also be referred to as flashware and may include hardware code for controlling initialization and certain operations of the card. As part of the initialization, the firmware may establish communication between the card and the host. Blocks 504, 508, and 510 establish whether the card initializes properly on each power cycle or initialization. Assuming the boot block is found 504, the last boot page can be read without UECC 508, and the file system map can be read 510, the card can be initialized and the firmware loaded 512 using the card's normal boot block process, which handles the initialization and booting of the card. As discussed below, an error condition may result in the initialization and booting originating from the protected block in the flash memory (i.e. the USERROM).

When any of blocks 504, 508, and 510 fail, test mode commands are sent to the USERROM in block 506. In other words, if the boot block is not found 504, the last boot page has an UECC 508, or the file system map cannot be read 510, the USERROM is read in block 506. Test mode commands may be special access sequences for gaining access to the USERROM. Since the USERROM is a protected block, there is no regular user mode and regular users cannot use or access the USERROM. The special access commands may provide access to the USERROM for reading in block 506.

In block 514, the USERROM is checked for booting. If the USERROM is not valid for boot, then the card is put into ROM idle mode in block 516. In other words, if the USERROM is not valid then booting fails and the card cannot be initialized. The USERROM may be used a backup or last option for booting and initializing the card when the regular boot block is overcycled or there is another error condition. When the boot block is searched for, it is checked for validity by looking for a specific signature. When the USERROM does not have the specific signature in block 514, then it is determined not to have valid data and the boot fails in block 516.

When the USERROM is valid for boot, the firmware is loaded and the card is initialized in block 518. Since the firmware loaded from booting through the USERROM may not be the most current version, the boot and file system are searched for updated versions in block 520. The file system map may be a separate block from the boot data on the card, so upon boot from the USERROM in block 518, the file system map may be located along with a newer version of the boot block stored on the card. The current version of the boot block may have been overcycled, corrupted, or could not boot for some reason, which is why the card may utilize the USERROM instead. Since the boot block stored in USERROM may not be current, the current version of the boot block on the card along with the file system is searched for on the card in block 520. In particular, there may be error recovery routines that are initiated when the card is booted from the USERROM. For example, the single layer cell (SLC) dynamic read may be initialized for searching for the updated version of boot. Then the updated or most current version (as opposed to the version from USERROM) may be loaded and used by the host to re-initialize the card in block 512. In other words, when the card is first initialized through the USERROM it may still be re-initialized using a more current version of the boot code stored elsewhere on the card in block 512 as long as it is found in block 520. In block 522, the card waits for commands from the host. In one embodiment, the corrupted boot block on the card is recreated based on the boot block from the USERROM that successfully initialized the card in block 518. In another embodiment, the older version of the boot block from the USERROM may be updated based on the current version of the boot block being found.

Card initialization with no boot or read errors results in loading the current or updated version of the firmware from the card. However, an error or problem with card initialization upon any power cycle may initiate booting from the USERROM. Since the ROM boot code and associated firmware may not be the most current, the updated version is searched for along with the file system. A more current version of the firmware may be used to update the USERROM boot initialization of the card, which may result in reinitialization with the current version, and may also be used to update the firmware associated with the USERROM to the current version. In other words, the USERROM provides an auxiliary method for initializing a card that would otherwise have failed. After backup initialization from the USERROM, the card may be reinitialized using the current/updated version of the boot block that was not from the USERROM.

The additional boot code added to the ROM for accessing this auxiliary booting process may be small without adding complexity. In other words, the standard boot process and ROM functions will not be hindered by the presence of the auxiliary boot through the USERROM. Single level cell (SLC) endurance may be improved with the proposed ROM boot process. The ROM may require two SLC structures for the proper functioning of a card, including the boot block and the file system.

Overcycling a control block or receiving a read error during initialization (so that the firmware cannot be accessed) may result in the card being in ROM mode and effectively unavailable to the user. As discussed with FIG. 5, a backup booting process may include loading the firmware from the USERROM when the main or primary source for loading the firmware fails or is corrupted. The main or primary source for loading the firmware may be located on the card, while the backup source for loading the secondary or backup firmware is located in a protected read only block that is referred to as USERROM. The secondary or backup firmware may not be the most current version, and will likely be the version current as of the first formatting of the card. After the backup boot process, the firmware scans for the primary or current firmware which may be used for a reinitialization of the card. The firmware associated with the USERROM backup boot may be a read only copy that is used to boot the card as the last option. It may also be considered to be backup ROM code or ROM code extension.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for initializing a memory system comprising:
in a non-volatile storage device having a controller and blocks of memory, the controller:
attempts to boot the non-volatile storage device upon each power cycle;
accesses a protected block of the non-volatile storage device when the attempts to boot fail, wherein the protected block comprises one or more of the blocks of memory that provide an auxiliary boot process;
determines whether the auxiliary boot process is valid;
boots the non-volatile storage device with the auxiliary boot process when the attempted boot fails and when the auxiliary boot process is valid.

2. The method of claim 1 wherein the protected block stores a boot block for initiating the auxiliary boot process and stores a backup firmware that is loaded as part of the auxiliary boot process.

3. The method of claim 2 wherein the boot block and the backup firmware are stored in the protected block when the memory system is first initialized with original firmware.

4. The method of claim 1 wherein the attempts to boot the non-volatile storage device upon each power cycle are from outside of the protected block.

5. The method of claim 1 wherein at least one of the blocks of memory stores a regular boot block stored outside of the protected block for the attempts to boot the non-volatile storage device.

6. The method of claim 1 wherein the auxiliary boot process comprises loading backup firmware that is stored in the protected block in the non-volatile storage device.

7. The method of claim 6 wherein the controller:
identifies a current version of the firmware other than the backup firmware; and
updates the backup firmware with the current version of the firmware.

8. The method of claim 7 wherein the controller:
re-initializes the flash memory system by loading the current version of the firmware.

9. The method of claim 7 wherein the firmware that is loaded from the auxiliary boot process is an older version than the current version.

10. The method of claim 1 wherein the controller accesses the protected block in the non-volatile storage device by sending test mode commands to the protected block, wherein the protected block comprises read only memory.

11. A flash memory device comprising:
a non-volatile storage having an array of memory blocks storing data; and
a controller in communication with the non-volatile storage, the controller is configured for:
identifying when a first firmware of the flash memory device cannot be loaded during the initializing of the flash memory device;
accessing a boot block stored in a protected block in the non-volatile storage when the first firmware of the flash memory device cannot be loaded;
initializing the flash memory device from the boot block stored in the protected block, wherein the initialization includes loading a second firmware for the flash memory device; and
updating the flash memory device from the second firmware.

12. The device of claim 11 wherein the first firmware is stored outside the protected block and the second firmware is stored inside the protected block, further wherein the first firmware is loaded as part of a standard boot process while the second firmware is loaded as part of an auxiliary boot process.

13. The device of claim 11 wherein the updating the card from the second firmware comprises:
searching, after initializing from the boot block stored in the protected block, for the first firmware; and
performing another initialization that includes loading the first firmware.

14. The device of claim 11 wherein the second firmware is stored in the non-volatile storage and is an older version of the first firmware.

15. The device of claim 11 further comprising repeating the initialization of the flash memory device upon each power cycle.

16. The device of claim 11 wherein the boot block and the second firmware are stored in the protected block when the flash memory device is first initialized with original firmware.

17. A method for initializing a non-volatile storage device comprising:
in a memory system having the non-volatile storage and a controller in communication with the non-volatile storage, the controller:
booting the non-volatile storage device from a protected read only memory on the non-volatile storage device;
loading a backup firmware as part of the booting from the protected read only memory;
identifying a regular firmware on the non-volatile storage device after booting from the protected read only memory, wherein the regular firmware is stored outside the protected read only memory; and
updating the non-volatile storage device with the original firmware.

18. The method of claim 17 further comprising:
attempting to boot the non-volatile storage device upon each power cycle using a regular booting process that is not from the protected read only memory.

19. The method of claim 18 wherein the booting from the protected read only memory occurs when the attempting to boot using the regular booting process fails.

20. The method of claim 17 wherein the updating the non-volatile storage device with the regular firmware further comprises:
re-initializing the non-volatile storage device by loading the regular firmware after initially loading the backup firmware.

21. The method of claim 17 wherein the non-volatile storage device comprises a flash memory or a solid state memory.

22. The method of claim 17 wherein the backup firmware is stored in the protected read only memory along with a backup boot block that is used for the booting from the protected read only memory.
